(19) United States
(12) Patent Application Publication
(10) Pub. No.: US 2019/0177221 A1
(43) Pub. Date: Jun. 13, 2019

(54) USE OF TREATED DESERT SAND AS AGGREGATE FOR CONCRETE

(71) Applicant: KHD HUMBOLDT WEDAG GMBH, Koeln (DE)

(72) Inventor: Jörg BINNER, Engelskirchen (DE)

(73) Assignee: KHD Humboldt Wedag GmbH, Koeln (DE)

(21) Appl. No.: 16/092,930

(22) PCT Filed: Apr. 7, 2017
(86) PCT No.: PCT/EP2017/058375

§ 371 Date: Oct. 11, 2018

(30) Foreign Application Priority Data
Apr. 11, 2016 (DE) 10 2016 004 349.0
Feb. 6, 2017 (DE) 10 2017 102 225.2

(51) Int. Cl. C04B 14/06

(52) U.S. Cl. CPC C04B 14/068

(57) ABSTRACT

Desert sand is treated to be used as an aggregate for concrete, a method for producing an aggregate for concrete is provided, and to an aggregate for concrete is provided. The aggregate is obtained by crushing desert sand in a high-pressure roller press, wherein, in a first stage, the desert sand in a bed is crushed by pressure exposure, and then forms agglomerates. In a second stage, the agglomerates are disrupted by further mechanical exposure. The pressure exposure in the first stage is accomplished by a single pressing between two surfaces at more than 50 MPa pressure. Aggregate produced in this way results in substantially greater concrete strength than when untreated desert sand is added.

### CROSS-REFERENCES TO RELATED APPLICATIONS

This application claims the benefit of the International Application No. PCT/EP2017/058375 filed on Apr. 7, 2017, and of the German patent application No. 10 2017 102 225.2 filed on Feb. 6, 2017, and of the German patent application No. 10 2016 004 349.0 filed on Apr. 11, 2016, the entire disclosures of which are incorporated herein by way of reference.

### BACKGROUND OF THE INVENTION

The invention relates to the use of treated desert sand as an aggregate for concrete.

The utilization of conventional sand as an aggregate for concrete is known. The aggregate forms a filler which does not influence the strength of the concrete, and which is bound by the binder, which is composed of ground cement clinker, concrete admixtures and concrete additives. The concrete admixtures influence the setting behavior of the concrete and its rheological properties. The concrete admixtures are chemically active in the setting concrete—such as water, for example. Empirical investigation of concrete strength has revealed that sand aggregate of differing provenance has a very considerable influence on the concrete strength. Although the majority of sand grades utilized as concrete aggregate consist very largely of fragmented quartz, there are various grades of sand which also include fractions of rock containing carbonate, if the sand is beach sand, for example, or rock containing granite or basalt, if the sand comes from gravel pits. The provenance of the sand therefore determines its chemical composition, the particle size distribution, and also the particle morphology. The worldwide demand for construction sand is great. As an industrial product, sand occupies third place in worldwide consumption. The worldwide annual demand for sand runs to about 15 billion metric tons. Because of the scarce reserves of sand which is suitable as a concrete admixture, construction sand is now being obtained from the sea, using ships. For this purpose, the suitable sand is transported with ships over large sea distances.

There is also very great demand for construction sand in countries having extensive sand deserts or in countries close to extensive sand deserts, hence suggesting the use of desert sand as a concrete aggregate. Desert sand, unfortunately, and particularly if taken as surface sand or as dune sand, has a circular to spherical sand morphology. The particle morphology comes about from the rolling of the sand over millions of years within the desert, with the individual grains being well and truly ground to sphericity. Beach sand as well, which is continually revolved by the breakers, has a rounded shape to the individual grains of sand. Desert sand as such is therefore not suitable for use as a concrete aggregate for concrete applications requiring particularly strong concrete. For tower constructions, bridge constructions, and underwater foundations, the requirement is generally for a geologically young fractured sand, which is obtained in general from rivers, where the sand is eroded from moraines. It may therefore be necessary to transport sand, a highly complex and costly operation, into sandy desert regions to allow it to be used there as construction sand.

### SUMMARY OF THE INVENTION

It is an object of the invention, therefore, to develop a method by which desert sand can be used as an aggregate for concrete.

This object of the invention is achieved by the desert sand having been crushed beforehand in a high-pressure roller press, wherein in a first stage the desert sand in a bed is crushed by pressure exposure, and agglomerates, and then in a second stage the agglomerates are disrupted by further mechanical exposure, the pressure exposure in the first stage being accomplished by single pressing between two surfaces at more than 50 MPa pressure.

### DETAILED DESCRIPTION OF THE PREFERRED EMBODIMENTS

In accordance with the invention, then, desert sand having substantially spherical particle morphology is run through a high-pressure roller press, of the kind first published according to Schönert et al. in German laid-open specification DE 27 08 053, the disclosure content of which is incorporated into the present specification. On passage of the desert sand having substantially spherical particle morphology through the first stage of the high-pressure roller press, through the roll nip of two roll surfaces at more than 50 MPa pressure, the desert sand is crushed and forms a jagged and irregular particle morphology, approximately comparable to the irregularity of rock chippings as customarily used for road building in Europe. Because of the formation of the irregular, jagged particle morphology, this desert sand thus treated suddenly tends towards agglomeration, resulting in formation of flakes which, in a second stage, are disrupted by further mechanical exposure. Especially suitable as this second stage are centrifugal classifiers, in which the highly fragile flakes fall over metal plates which are arranged in the manner of a venetian blind; in so doing, the flakes break up and the treated desert sand is liberated from its agglomeration. This crushed desert sand is screened out of the milling circuit by a corresponding centrifugal classifying method, when the high-pressure roller press is in a circuit mill, or the desert sand is crushed by a single pass through the high-pressure roller press with flake deagglomerator. Treating the desert sand in a Schönert et al.-type high-pressure roller press breaks the grain of the desert sand, and a finer grade is formed. Consequently, for the concrete formulas known per se which also prescribes the grading of the sand used as concrete aggregate to the statistical form known as RRSB (Rosin, Rammler, Sperling and Bennet) distribution, it must be ensured that the coarse material as milling material has a correspondingly coarser particle size. The crushed desert sand must then be brought to the specified particle size distribution by the known means of centrifugal classifying and sand mixing. The sand obtained by the Schönert et al.-type high-pressure treatment has the property, surprisingly, of forming a steeper angle of repose in a bed than does the spherically grained desert sand. This differentiates the sand treated by a high-pressure roller press from sand originating from milling in an edge runner mill or vertical mill The formation of the steeper angle of repose derives from the fact that the sand subjected to Schönert et al.-type high-pressure treatment has a particle morphology which leads to wedge-like interlocking of the individual grains of sand in the bed. A supposition here is that the same geometric properties of the sand crushed by high-pressure treatment mean that the concrete strength of the freshly crushed desert sand is higher than for other natural sand grades. A further supposition is that the fresh fracture edges of the crushed desert sand have not as yet undergone chemical passivation, meaning that the reactivity at the fracture face of the sand is higher, thus forming a crystalline bond between the setting cement clinker and the fresh fracture edge of the crushed sand. Naturally aged sand has surface-grown oxide layers, iron oxide or phosphate layers, which attenuate or prevent direct reaction of the calcium silicate phases which form, from the cement clinker, with the quartz fracture edge of the sand. The high-pressure treatment apparently leads to larger individual fracture faces in the microstructure of the individual grain of sand than does comminution by a shearing treatment, in which the coarse grain is characterized, in particular, by grinding tracks. The finer milled material in that case does have a fresh surface, but the particle morphology is essentially spherical.

Having emerged as being particularly suitable is, in particular, desert sand treated by the Schönert et al.-type high-pressure treatment and having Dubai, Oman, The United Arab Emirates and Saudi Arabia, or else Morocco, as its provenance. The 7-day strength, 40-day strength and 100-day strength of sand treated with high-pressure exposure at 50 MPa has proved to be sufficient for use in the construction of high-rise buildings, bridges and underwater foundations. The criteria of concrete strength are set down in the corresponding standards, such as DIN 1045 and DIN 1992, for example. The formulas for the concrete desired in each case, particularly the particle size distributions of the sand to be used, are also stipulated in the relevant concrete handbooks. The stipulated grading and particle size distribution may be adjusted, during production of the sand crushed by high-pressure treatment, through known means such as classifying and mixing.

In an embodiment of the method it is possible to comminute the desert sand in circulation. For this purpose, the sand, after passage through the roller press, is continually returned, pneumatically or via a mechanical conveyor, and fed again to the roller press. For extraction of the milled material, i.e., the crushed desert sand, the circulating sand as milling material is classified by means of a static classifier or a dynamic classifier, such as a rod cage classifier. The fine material leaves the circulation grinding system, and the grit, as the coarse material from the classifier, is recirculated. In order to set the correct particle size distribution, the crushed desert sand is brought to the desired particle size distribution by screening, something which may also take place in the aforementioned circulation.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1-7. (canceled)

8. A method for preparing desert sand as aggregate for concrete, comprising the steps:
crushing the desert sand, in a first stage, in a high-pressure roller press by pressure exposure in a single pressing between two surfaces at more than 50 MPa pressure and thereby forming agglomerates, thereafter
disrupting the agglomerates, in a second stage, by further mechanical exposure.

9. The method according to claim 8, including a step of obtaining a desired grading and particle size distribution by centrifugal classifying and mixing of different milled-sand grades.

10. The method according to claim 8, including the steps of
Milling the desert sand in circulation, and
Extracting the crushed desert sand from the circulation by at least one of classifying or screening.

11. A method for producing an aggregate for concrete, comprising the steps
crushing desert sand, in a first stage, in a high-pressure roller press by a single pressing between two surfaces at more than 50 MPa pressure to obtain agglomerates, and then
disrupting, in a second stage, the agglomerates by further mechanical exposure.

12. The method for producing an aggregate for concrete according to claim 11, including a step of obtaining a desired grading and particle size distribution by centrifugal classifying and mixing of different milled-sand grades.

13. The method for producing an aggregate for concrete according to claim 11, including the steps of
milling the desert sand in circulation, and
extracting the crushed desert sand from the circulation by least one of classifying or screening.

14. An aggregate for concrete, comprising desert sand that has been crushed in a high-pressure roller press by a single pressing between two surfaces at more than 50 MPa pressure to form agglomerates, and the agglomerates have been disrupted by further mechanical exposure.

15. The aggregate for concrete according to claim 14, wherein the crushed desert sand has a jagged and irregular particle morphology.
